(19) United States
(12) Patent Application Publication
(10) Pub. No.: US 2021/0039315 A1
(43) Pub. Date: Feb. 11, 2021

(54) VACUUM BED WITH BASE MEMBER FOR THREE-DIMENSIONAL PRINTING

(71) Applicant: NORTHWORKS AUTOMATION, INC., HOUSTON, TX (US)

(72) Inventors: Lawrence Ciscon, HOUSTON, TX (US); James D Wise, Houston, TX (US); John Hyatt, Sugar Land, TX (US)

(21) Appl. No.: 17/072,663

(22) Filed: Oct. 16, 2020

Related U.S. Application Data
(63) Continuation-in-part of application No. 15/713,519, filed on Sep. 22, 2017.
Application No. 15/713,519 is a continuation-in-part of application No. 15/659,433, filed on Jul. 25, 2017, now Pat. No. 10,189,205.
Application No. 15/659,433 is a continuation of application No. 16/865,175, filed on May 1, 2020.

(51) Int. Cl. B29C 64/245; B29C 64/295

(52) U.S. Cl. CPC B29C 64/245; B33Y 30/00; B29C 64/295

(57) ABSTRACT

An improved 3D printer includes an airflow enabled print bed ensuring secure placement of a print base prior to printing. The modular assembly technique provides for improved ease of manufacture and assembly, as well as adjustments of print sizing. The improved printhead includes a heat sink disposed internally therein for improved heat and cooling properties. The printhead itself includes z-axis position detection techniques. The inclusion of VSU insertion techniques in software modeling and printing further improves the print operations by including vertical stability for the print object.

### RELATED APPLICATION

The present application relates to and claims priority to, as a continuation-in-part application from, U.S. patent application Ser. No. 15/713,519 entitled THREE-DIMENSIONAL PRINTER filed Sep. 22, 2017, which is a continuation-in-part of and claims priority to U.S. Pat. No. 10,189,205 filed Jul. 25, 2017 entitled PRINTER HEAD Z-AXIS ALIGNMENT METHOD AND SYSTEM. The present application additionally relates to and claims priority to, as a continuation application from, U.S. patent application Ser. No. 16/865,175 entitled VACUUM SURFACE FOR THREE-DIMENSIONAL PRINTING filed May 1, 2020.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### FIELD OF INVENTION

The disclosed technology relates generally to three-dimensional (3D) printer technology and more specifically to vacuum bed technology for securing a print job in place during 3D printing.

### BACKGROUND

Deficiencies exist in the design of 3D printer systems, as well as 3D printing techniques.

3D printing uses vacuum forces to hold the print surface in place. Disconnecting the vacuum force after print completion allows for print job removal. Complications arise in the current print surface and vacuum bed technology, such as ensuring the print bed and the printing object remain stationary.

Current vacuum beds have holes or channels to hold down the print object. These holes or channels cause the print object to be held down at focused points rather than over the whole surface. If even one hole or channel becomes uncovered, this can break the vacuum seal, allowing the print object to shift. Current techniques can produce uneven hold-down forces.

Another known solution is manufacturing the vacuum table itself out of a permeable material. This solution is problematic because the cost of creating the vacuum table itself out of this material is prohibitively expensive. Another concern is the ability to generate and transfer the amount of heat required to heat up the print surface. Additionally, with the permeable nature of these solutions, there are stability and rigidity concerns on the vacuum bed being able to properly support print jobs.

Various existing solutions are described in U.S. Pat. No. 9,216,544. The first solution is the inclusion of vacuum holes, which in this embodiment are several small holes on the periphery of the print plate. In this solution, the holes hold down a film during printing. The film is on rollers and after printing, rotating the rollers slides the film across the print bed. A second solution uses a porous print surface with holes. These holes are not for vacuum airflow, but for receipt of deposition material during printing. As deposition material is deposited, the material fills into the holes and the print job is then secured against the print surface.

None of the existing solutions use a vacuum bed in combination with venting techniques and solutions for not only fixing the print surface in place during print jobs execution, but also ease of removal upon print job completion.

As such, there exists a need for a vacuum bed solution allowing for improved 3D printing and ease of removal of a print surface from the vacuum bed.

### BRIEF DESCRIPTION

An improved 3D printer includes a unique solution for securing a print surface within the 3D printer for deposition of print material. The 3D printer includes a vacuum bed with multiple air vents. A base member sits atop the vacuum bed, the base member is composed of a permeable material. And a print surface member is affixable atop the base member, the print surface being a non-permeable surface.

A vacuum, connected below the vacuum bed, provides airflow through the air vents, securing the base member onto the vacuum bed. The semi-permeable make-up of the base member allows airflow therethrough, the vacuum force secures the print surface member in place against the base member.

During 3D print, engagement of the vacuum secures the base member in place against the vacuum bed and the print surface member in place against the base member. As the print surface member is held in place, the deposition of print material enables for 3D printing by the 3D printer.

Upon print completion and termination of the vacuum force, the print surface member can be easily and quickly removed from the base member. The print surface member can be a pliable material, thus readily peeled away from or otherwise removed from the print job.

In one embodiment, a heating element may be included within or affixed to the vacuum table. The heating element can generate heat, translated through the base member and against the print surface. This heat aids in the deposition of print material. The semi-permeable makeup of the base member allows not only air flow therethrough, but provides for efficient heat transfer to the print surface member.

### BRIEF DESCRIPTION OF THE DRAWINGS

FIG. 1 illustrates one embodiment of a vacuum print bed;

FIG. 2 illustrates one embodiment of a vacuum print bed with a base member and print surface member;

FIG. 3 illustrates a cross-section view of FIG. 2;

FIG. 4 illustrates a side view of a vacuum bed with airflow indications;

FIG. 5 illustrates a perspective view of a vacuum bed with airflow indications;

FIG. 6 illustrates a perspective view of one embodiment of a first 3D printer side component;

FIG. 7 illustrates a perspective view of one embodiment of a second 3D printer side component;

FIG. 8 illustrates a perspective view of one embodiment of another 3D printer bracing component;

FIG. 9 illustrates a perspective view of one embodiment of assembly of 3D printer components;

FIG. 10 illustrates a front view of one embodiment of a fastener assembly for mating pieces together;

FIG. 11 illustrates a perspective view of one embodiment of a printhead;

FIG. 12 illustrates another perspective view of the printhead of FIG. 11;

FIG. 13 illustrates a side view of one embodiment of a printhead within the calibration system;

FIG. 14 illustrates a side view of one embodiment of the printhead with the hotend in contacting engagement with a print bed;

FIG. 15 illustrates a circuit diagram of one embodiment of controller;

FIG. 16 illustrates one embodiment of modular hotend;

FIG. 17 illustrates one embodiment of modular controller;

FIG. 18 illustrates one embodiment of an x-y position controller for a 3D printer assembly;

FIG. 19 illustrates a sample cross-section of a print object having stability members inserted therein; and

FIG. 20 illustrates a flow diagram of one embodiment of a technique for insertion of stability members.

A better understanding of the disclosed technology will be obtained from the following detailed description of the preferred embodiments taken in conjunction with the drawings and the attached claims.

### DETAILED DESCRIPTION

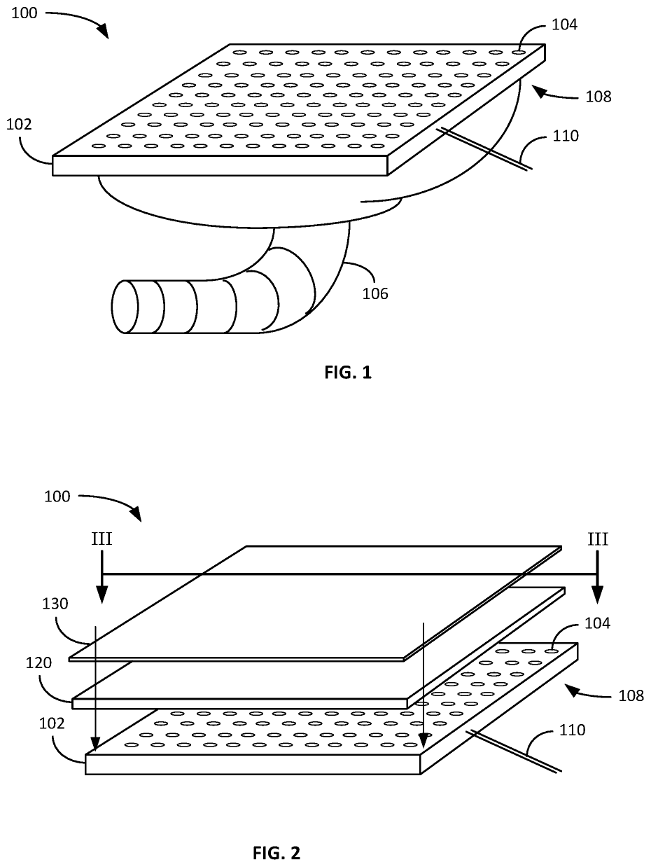

FIG. 1 illustrates a perspective view of a print bed 100 usable with 3D printing. The print bed 100 includes a vacuum bed 102 having a plurality of air holes 104 therein. A vacuum hose 106 is connected to a bottom side 108 of the bed 102. The print bed 100 further includes a heat element (not visible) disposed within its interior, the heating element including electrical leads 110.

The print bed 100 may be composed of any suitable material, such as but not limited to metal or plastic. The bed 100 allows for airflow through the holes 104. Varying embodiments allow for different sizing and placement of air holes, including one embodiment may include pin-prick size air holes, whereas other embodiments may include larger holes. Another embodiment may include channels extending across the bed 102. The specific sizing of the air hole 104 is not limiting, such that the air hole 104 in combination with the air hose 106 provides for air flow therethrough to generate the vacuum force.

While not directly illustrated, the air hose 106 connects to a vacuum or other type of suction device. The vacuum may be any suitable type of device operative to pull air in through the air holes 104 and down the tube 106. Varying degrees of vacuum force can be provided based on varying conditions, such as thickness of the vacuum plate, size and volume of holes, thickness of a base member, etc. By way of example, in one embodiment a vacuum force as low as 1 cubic foot per meter can be used to hold down the print surface.

In varying embodiments, the air holes are relatively small and can be any suitable size, such as, but not limited to, being ⅛″ spaced on 1″ centers. It is also recognized that in varying embodiments, the vacuum required is minimal, such as, but not limited to, 15 inches of mercury vacuum at 2-3 cubic foot per meter flow, as generated using one or more small pumps.

The print bed 100 is disposed within a 3D printer. Prior to printing, the heating element is powered on via the electrical leads 110. When heated to an acceptable temperature, the vacuum bed 102 provides a heated platform allowing for deposition of print material.

Different temperatures are prescribed for different deposition materials. In one example, if 3D printing uses ABS as the print material, this deposition temperature is between 210° C. and 250° C., the print bed may be heated to a temperature of around 110° C.

The print bed 100 can be subject to existing 3D printing set-up techniques. For example, the print bed 100 can be moveable within at least a Z-axis for print job set-up. The print bed 100 and the vacuum surface 102 require mass and rigidity for supporting 3D printing. During normal print operations, the 3D printhead generates downward forces, the print bed 100 needs enough mass and rigidity to encounter these forces without falling out of alignment. In an alternative embodiment, the print bed 100 may be a fixed structure. Whereas in either embodiment the print bed 100 includes the vacuum table 102 for facilitating the vacuum force as described herein.

FIG. 2 illustrates a perspective view of the 3D printer 100 including the vacuum bed 102 with air vents 104 and the electrical leads 110 for the internal heating element. A base member 120 is positioned on top of the vacuum bed 102 and a print surface member 130 is positioned on top of the base member 120.

The positional arrows illustrate the placement sequence prior to beginning a print job. The print surface member 130 is disposed on top of the base member 120, which then sits on top of the vacuum bed 102.

As described in greater detail below, the base member 120 is composed of a permeable material. The permeable material allows for dispersion of vacuum force generated through the air holes 104. The base member 120 can include sealed planar edges, whereby air flow is directed upward through the base member 120 and does not leak out the side.

In another embodiment, the base member 120 may include exposed or unsealed planar edges. The base member 120 having a limited thickness provides that for unsealed planar edges, there is minimal air pressure loss and thus does not adversely affect the overall vacuum force received by the print surface member 130. Similarly, with unsealed planar edges, the base member 120 can a cut-out portion of a large member.

In one embodiment, a sealant on the outer edge of the base member 120 can be used if the base member 120 is composed of a material prone to curling. The sealant can provide rigidity prohibiting curling.

The print surface member 130 is made of a non-permeable material. The dispersion of the vacuum force within the base member 120 is then applied against the print surface member 130. As to a planar edge sealant on the base member 120, if the print surface member 130 is subject to curling, a sealant around the planar edge could generate additional vacuum force countering curling.

In one embodiment, the print surface member 130 can be composed of a semi-permeable material capable of restricting airflow therethrough such that the vacuum force secures the print surface member 130 against the base member 120. The print surface member 130 may be any suitable element having enough surface area, but limited mass, to be held in place by the vacuum-generated airflow passing through the vacuum bed 102 and the base member 120. For example, the print surface member 130 may be a standard sheet of paper. In another example, the member 130 may be paper having surface contact on a top side allowing for improved connection with deposited print material. In another embodiment, the member 130 may be water-soluble, such that after printing operations, the print object and member 110 may be dipped in liquid to allow the paper to dissolve. The above examples are exemplary in nature and it is recognized that any other suitable type of print surface member 130 may be utilized, whereby the print base provides for being held in place by the airflow, but also receiving deposited print material, and being flexible or deformable to easy removal of the print object therefrom.

Prior art problems associated with the placement of air holes 104 are eliminated by inclusion of the base member 120 and the print surface member 130 described herein. Moreover, the base member 120 allows for printing jobs on standard vacuum tables instead of requiring cost-prohibitive vacuum tables composed of permeable material.

FIG. 2 illustrates the vacuum bed 102, the base member 120, and the print surface member 130 having complementary planar dimensions. In varying embodiments, these elements can have different planar dimensions. For example, the vacuum bed 102 has its fixed size, but the base member 120 may smaller in planar size, affixable in one region of the vacuum bed 102. The print surface member 130 can mirror the shape of the base member or be smaller or larger in planar dimensions, held in place via the vacuum forced dispersed within the base member 120.

Varying the sizes of the base member 120 and the print surface 130 facilitates variations of generating and timing print jobs with the 3D printer. For example, a first print job can be printed on a first print surface member resting on a first base member on top of the vacuum bed. Upon completion of that job, a second print job can be started on a second print surface member resting on a second base member on top of the vacuum bed. As the second print job executes, the first print job cools and can then be removed, eliminating downtime between print jobs.

In another embodiment, the multiple print jobs on different print surface members can be atop the same base member. In this embodiment, removal of the completed first print job can be manually done by manually breaking the vacuum force between the print surface and the vacuum bed while the second print job is active.

The print bed 100 is disposed within a 3D printer in accordance with known 3D printer technology. The printing of a 3D object includes standard operational features, including computer software for modeling prior to print, axial-based positioning, and pre-printing processing routines.

Heating the print bed is done prior to deposition of print material. Therefore, activation of the heating element by the electrical leads 110 heats the vacuum bed 102. The heat generated by the heat element reaches the print surface member 130. The permeable structure of base member 120 facilitates heat transfer therethrough, reaching the print surface member 120. The limited thickness of the base member also facilitates proper heat transfer.

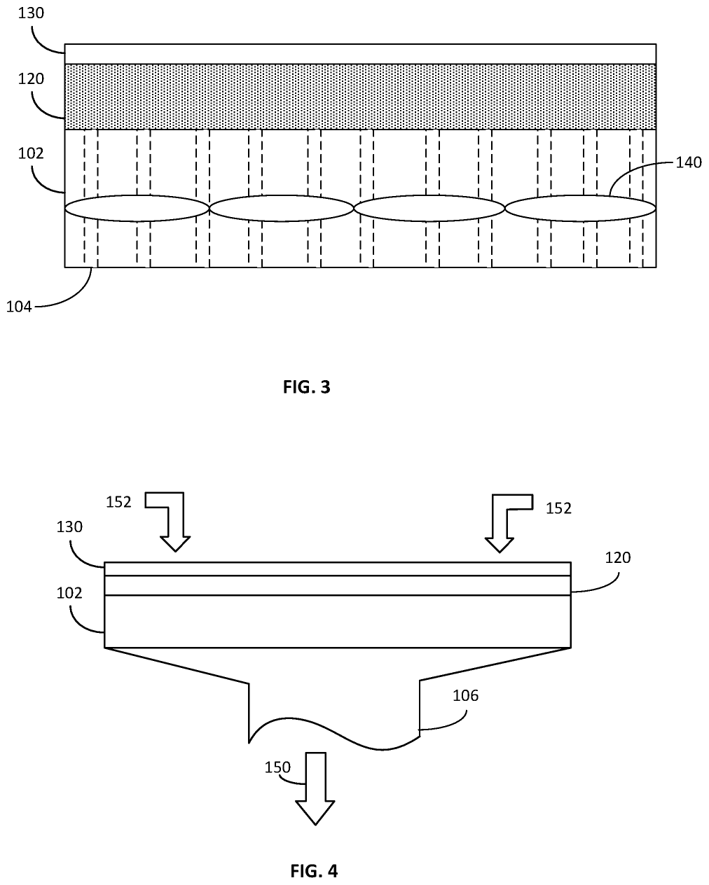

FIG. 3 illustrates a cross-sectional view of FIG. 2 across line Visible in the cross section is the vacuum bed 102, with air holes 104 shown in relief. The cross-section III-III further shows the interior of the base member 120 and the print surface member 130. Also visible, the heating element 140 is disposed within the vacuum table.

The base member 120 can be composed of any permeable material allowing for air flow to travel therethrough. In one embodiment, the base member can be composed of aluminum metal foam. For example, in one embodiment, the aluminum metal foam can have a density in the range of 0.1 to 0.35 g/cm3 with a pore size ranging from 2-11 mm. Further embodiments provide for the base member composed of other materials, for example, various types of papers such as construction paper, photo paper, newsprint, or other type of paper. Further embodiments also provide other types of permeable materials, such as cardboard, wood fiber board, foam, among others. The examples and dimensions listed herein are exemplary and not expressly limiting, as the base member 120 can be composed of any suitable permeable material.

Further facilitating the 3D printing, the base member 120 can have a limited thickness. The limited thickness reduces costs, reduces the amount of vacuum pressure required, and helps facilitate heat transfer. In one embodiment, the base member may have a thickness around 0.1 inches, ranging all the way down to a thickness of 0.001 inches. The above is exemplary and not expressly limiting, for example the thickness may be greater than 0.001 inches as well as less than 1 inch. In one embodiment, the base member thickness can range between 0.05 inches and 0.005 inches.

The print surface member 130 can be a thin piece of paper. Therein, when the print job is complete, the member 130 can then be peeled away from the print job. This then eliminates damaging the completed print job after the full printing is complete.

As used herein, the print surface member 130 can be any suitable material capable of having deposition printing thereon. For example, the print surface member 130 can be a standard piece of paper or in another embodiment it can be waxed or parchment type paper or a film having a coated surface.

FIG. 4 illustrates a side view of the vacuum force. The vacuum bed 102 includes the vacuum channel 106 below. During print operations, a vacuum (not expressly shown) operates to generate the vacuum force creating downward airflow, as illustrated by arrow 150. The vacuum force is a reverse air-pressure drawing the air downward 150 in the direction. The vacuum and vacuum force through the channel 106 is in accordance with known vacuum techniques.

The 3D printer of FIG. 4 varies by inclusion of the base member 120 and the print surface member 130 as described herein. As the vacuum force 150 pulls downward, this force seeks to pull airflow through the holes (104 of FIG. 1), affixing the base member 120 against the vacuum bed 102.

Where prior solutions use the vacuum bed 102 with multiple air holes 104, these prior solutions suffer from various complications, including for example a lack of vacuum pressure if an air hole is not properly sealed against a print surface, crimping, puckering, or other deformations of the print surface caused by the air holes.

The present 3D printer, by inclusion of the base member 120 composed of permeable material, corrects problems associated with the prior solutions. The permeable material creates a dispersion of the vacuum force 150, which is then evenly distributed across the print surface member 130.

Where FIG. 4 illustrates the air flow direction 150, this creates a downward force 152 securing the print surface member 130 to the base member 120.

In varying embodiments, additional securing means can be used to further secure the base member 120 to the print surface member 130. These securing means can include varying amounts of adhesive in one or more locations between the base member 120 and the print surface member 130. Using additional securing means allows for ensuring connection of the members 120, 130 when the vacuum is not engaged, such as prior to beginning a print job and print job removal.

Therein, by using the base member 120 and the print surface member 130, the 3D printer additionally facilitates easy removal of the subsequent print job. Prior 3D printer solutions require the vacuum bed to fully cool prior to removal of the print job. Whereas, the permeable layer allows for removal of the print surface 130 from the base member 120 upon disengagement of the vacuum force.

Additionally, further print jobs can be quickly started without requiring pre-heating. Therefore, the present 3D printer allows for quick transition between print jobs using the base member 120 as the intermediate layer between the vacuum bed 102 and the print surface member 130.

In one embodiment, the 3D printer can be operated within a print farm providing for high speed or quick turn-around printing of either a large number of print jobs or using different printers for different components. The present system allows for quick transition between print jobs or transitioning a print job between different printers.

The permeable material of the base member 120 allows for quick and efficient removal of the print surface member 130 from the base member 120. In the embodiment of using vacuum pressure, disconnecting the air flow allows for the print surface member 130, having the print job resting thereon, to be simply lifted up and removed. If adhesive is used between the members 120 and 130, the base member 120 can be lifted up and removed from the heat source of the vacuum table. This allows for quicker cooling, allowing for the print surface member 130 to be peeled away from the base member 120.

Similarly, if the print job is transferred out of the 3D printer, such as wanting to make room for another print job, the user does not need to wait for the vacuum table to completely cool. Disconnecting the vacuum stops the vacuum force, allowing the base member 120 (with the print surface still attached) to be lifted up and out. This allows insertion of a replacement base member and print surface member for beginning another print job.

Similarly, the inclusion of two layers, the base member 120 and the print surface member 130 provides for these layers to have similar heat expansion behaviors. This means these layers can uniformly expand and contract in response to external temperature fluctuations, avoiding warping or curling during heating.

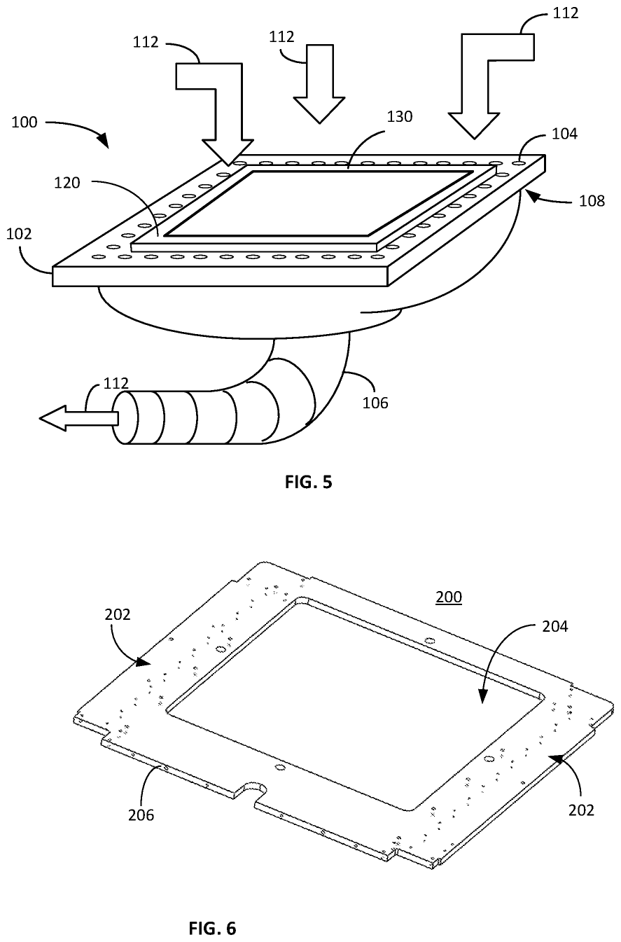

FIG. 5 illustrates a perspective view of the vacuum bed 102, the base member 120, and the print surface member 130. Similar to FIG. 4, airflow 112 passes through the vacuum bed 102, through the base member 120 to hold the print surface member 130 in place.

The present 3D printer enables a larger variety of deposition material printing. Prior 3D printers are optimized to one type of deposition material, but can struggle with different deposition materials based on printing requirements, including temperature variations and print surface material requirements. The use of the permeable base member allows for greater variety of deposition materials for different types of 3D print jobs using the same 3D printer.

Herein, the permeable base member 120 generates a low-resistance dispersion of vacuum forces over the entire surface. The vacuum holes (104 of FIG. 1) generate a higher resistance over a discrete point, where the base member creates a uniform force against the print surface member. This has the advantage that it provides a much better print surface while the print surface member can retain its advantages of being a thin, peel-able layer.

Further embodiments allow for varying the size or number of the holes or air flow channels for the vacuum bed. For example, FIG. 1 illustrates a grid of holes, but one embodiment can include a large aperture, the vacuum bed including an exterior frame for supporting the base member. The vacuum bed can additionally include other varieties for generating the heat source, such as exposed heat elements or any other suitable means to generate the heat requirements for proper 3D printing.

Varying embodiments also allow for different sizing of the base member and the print surface members. For example, the above figures illustrate the base member and the print surface member as having the same length and width dimension. It is recognized these members do not require having the same area, such as the print surface area being smaller in width and length from the base member.

The present printing method and system further enables high speed multiple job printing solutions. Prior limitations of heating up the vacuum bed before printing and cooling down prior to print job removal are eliminated. The dispersion of the vacuum force through the base member and its limited thickness facilitate heat transfer for quickly starting print jobs. Similarly, the base member 120 creates an intermediate layer that allows for print job removal not dependent on the heat of the vacuum bed and the print surface member. Rather, removal is based on lifting the print surface member from the base member.

The dispersion of the vacuum force inhibits puckering, buckling, or other deformations of the print surface member before and during 3D printing. The relation of vacuum force between the vacuum bed 102 and base member 120 is no longer dependent on the full coverage of a print surface over the bed. Where prior solutions suffered from any inadvertent loss of vacuum pressure between the print surface and the vacuum bed, the vacuum force dispersion of the base member eliminates this concern.

Similarly, the relation of the vacuum bed, the base member, and the print surface member allows for multi-job print with high speed print job transitions. As noted above, the vacuum bed can have multiple print jobs disposed thereon, with different base members in different zones, with print surface members atop the base members. In another embodiment, the base member itself can have multiple zones with multiple print jobs atop the single base member.

In one embodiment, the wiring of the vacuum (not illustrated) may be connected or integrated into the 3D printer itself, such that turning on the 3D printer thus turns on the vacuum. In another embodiment, the vacuum may include its own switch. Whereas in another embodiment, the vacuum may be separately electronically engaged by computerized controls, including engaging the vacuum at a time prior to beginning printing, for example after completing printhead position calibration operations.

Engaging the vacuum during print operations holds the print base member 130 in place by the airflow 112 while the 3D printer deposits material. When the print job is complete, the airflow 112 terminates, allowing for ease of removal of the print surface member 130 having the print job thereon.

In the embodiment of a water-soluble print surface member 130, the print job may be placed in water, allowing the print surface member 130 to simply dissolve. In other embodiments, the print job may be forcibly removed from the print surface member 130, such as by simply peeling off the print surface member 130.

In previous 3D printers, problems can arise with the removal of the completed print job from the print bed. When printing is done directly on the print bed, dirt and other artifacts can affect the print job, as well as complicating separation of the print job from the print base upon print completion. Utilizing the airflow secures the print surface member 130 against the base member 120 for improved printing operations and print job extractions.

The vacuum print bed 100 further improves overall system efficiency by eliminating cooling times associated with print object removal. Prior print bed techniques require heating the bed prior to printing and cooling the bed for removing the print object. The vacuum print bed 100 secures the base member 120 and print surface member 130, thus eliminating heating and cooling cycles. For example, prior techniques may require an hour to heat the print bed, an hour for the print bed to cool for object removal, and then another hour to begin printing again. In this instance, the 3D printer itself is idle for three hours between print jobs. Whereas, the print bed 100 allows for instant removal of the print surface member 130 by disrupting the airflow and then allowing for printing another object directly thereafter, eliminating unnecessary delay between print jobs. As used herein, a print job is any defined printing operation, such as but limited to: printing a portion of a print object where another print job completes or complements the print job; printing a complete print object; printing multiple print objects or portions of print objects.

In another embodiment, the print bed 100 may include multiple zones, where air flow can be controlled on a per zone basis. For example, one embodiment may include a flap or shutter turning air flow off for one or more zones, but leaving air flow on for other zone(s). In this embodiment, the 3D printer may engage multiple print jobs on a common print bed, thus turning off a zone allowing for removing completed print jobs.

The zone control can include control mechanisms relating to dividing the airflow from the vacuum, such as disabling a zone by cutting off vacuum airflow reaching the specific zone. This may include a flap or shutter for specific zones. Zone control can also include blocking the air holes in a specific zone, such as a closure blocking off a bottom side of the air hole.

The present vacuum bed uses multiple air holes dispersed across the top of the vacuum bed. With a vacuum force applied, air pressure generates the downward force from the top of the vacuum bed. The multiple air holes can focus airflow and air pressure, minimizing force required by the vacuum itself but generating the air pressure to secure the base member in place.

Moreover, the use the multiple air holes minimizes or eliminates any deformation to a print surface caused by the inward air pressure. The use of multiple air holes evenly distributes the holding force applied against the base member, ensuring a higher quality 3D print job.

The base member further distributes the inward air pressure holding the print surface in place without any deformation. In prior art techniques of using a vacuum bed with a print surface member, the air pressure creates deformations in the print surface member, for example causing an inward billowing as the member is pulled into the holes in the vacuum bed. The base member evenly distributes the air pressure eliminating deformations of the print surface member.

Current 3D printers additionally suffer from complicated framing assemblies. High accelerations of the printhead in all three axes requires high stiffness in the 3D printer frames.

FIG. 6 illustrates an improved 3D printing assembly structure of a first panel 200 with apertures 202 and a center opening 204. The panel 200 further includes fastener holes 206 disposed along a side plane. The panel 200 may be made of any material having a high tensile strength providing rigid stability.

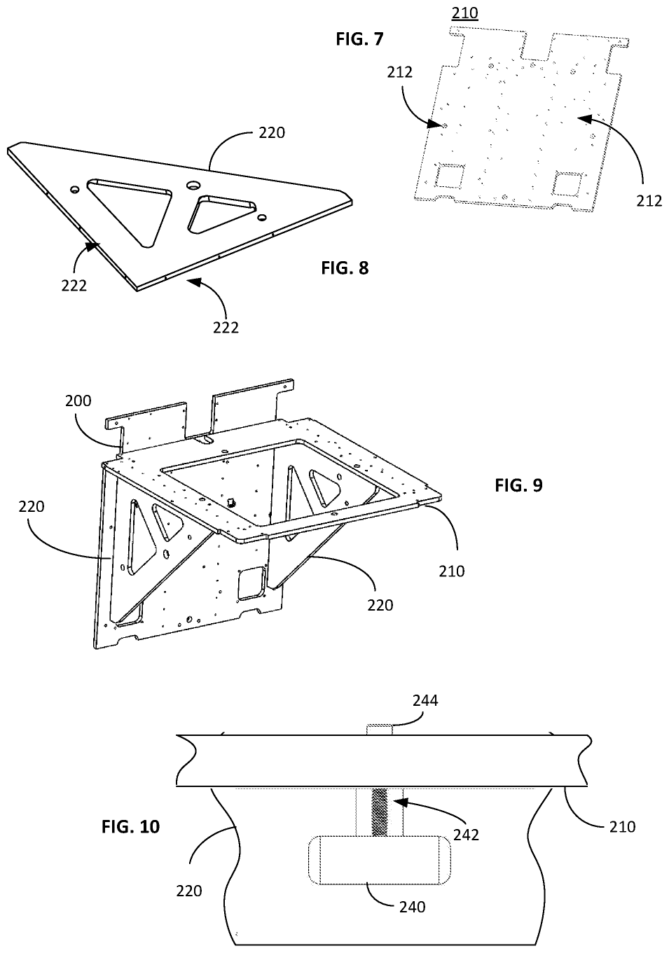

FIG. 7 illustrates another panel 210 of an improved 3D printing assembly, having apertures 212. Similar to the panel 200 of FIG. 6, this panel 210 may be made of any material having a high tensile strength providing rigid stability.

The panels 200 and 210 of FIGS. 6 and 7 may include any suitable number of apertures 202, 212 of varying sizes at varying locations. The general rigidity of panels 200 and 210 allow for improved stability in the 3D printer assembly, where placement of apertures allows for varying the size of the 3D printer, including larger or smaller print bed allowing for varying sizes of print jobs.

In FIG. 8, a mating member 220 provides for mating panels 200 and 210 of FIGS. 6 and 7. The mating member 220 includes fastener holes 222 disposed along side edges. The mating member 220 may be made of similar material as panels 200 and 210. Moreover, in one embodiment, the panels 200, 210 and member 220 are composed of the same material to avoid manufacturing differences or structural differences brought upon by heat from the 3D printer or extended exposure to multi-axis movement forces by the 3D printer assembly. For example, in one embodiment the panels 200, 210 and member 220 are composed of thick aluminum sheets having a thickness between ½″ and ¾″.

FIG. 9 illustrates a perspective view of the mating of the panel 200 with panel 210, as secured by the mating member 220. Fasteners extend through the apertures 202 and 212, received into the fastener holes 222 of the mating member 220. Also securing the panels together, fasteners extend through the panel 210 into the holes 206 (not visible) of panel 200. The fastener holes 206, 222 may include internal grooves for holding the fasteners in place, whereas in other embodiment glue or other types of adhesive can be utilized. It is recognized that varying embodiments and fastening means may be utilized, as recognized by one skilled in the art, for securing the panels 200 and 210 to the members 220.

Another embodiment for mating pieces together is to use a finger-slot attachment. FIG. 10 illustrates a front view illustrating one embodiment of this finger slot attachment. The plate 210 is positioned against member 220, the member 220 having a finger slot receiving portion 240. A fastener 244 is inserted through an aperture in the plate 210, with threads 242 engaging the receiving portion 240.

The finger slots remove the need to drill a hole through the ends of the plates, improving manufacturing and assembly efficiencies. Moreover, the finger slot allows for ease of construction by simply engaging the threaded portions 242 of the fastener 244 into the receiving portion 240 in the mating member 220.

As illustrated in FIG. 9, the assembly of the panels 200 and 210 can be readily adjusted for changes in the 3D printer sizing. The panels 200 and 210 include multiple rows of apertures as varying positions

These panels 200, 210 and member 220 help define an outer structure for housing the 3D printer assembly. Where panel 200 includes the opening 204, panel 210 does not have an opening because z axis rails are mounted down the middle of the plate, where the z axis rails are described in further detail below. Thus, multiple panels 200, 210 are assembled and interconnected by members 220 to define the outer shell of the 3D printer, the outer shell having improved rigidity and stiffness for long term 3D printing without adverse effects of multi-axial vibrations from the movement of the printhead during printing operations.

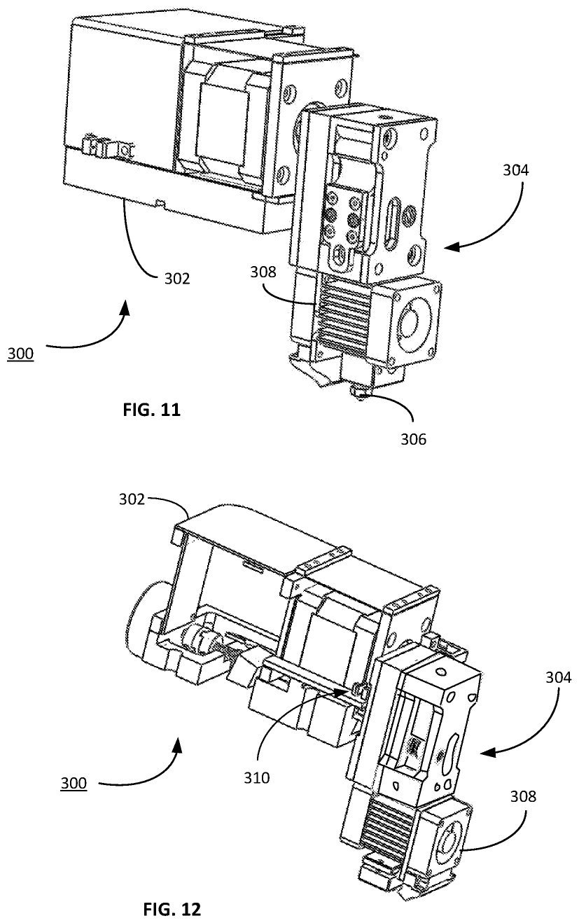

A further improvement in the 3D printing is achieved by the functionality of the printhead for depositing print material. FIG. 11 illustrates one embodiment of an improved printhead 300.

FIG. 11 illustrates a perspective view of the 3D printhead 300 capable of using the position calibration functionality as described in U.S. Pat. No. 10,189,205, priority to which is claimed herein. The disclosure of U.S. Pat. No. 10,189,205 is incorporated by reference.

The printhead 300 includes a print module 302, also commonly referred to as a controller, and a hotend 304 with a deposition head 306 directly below a heat sink 308. The print module 302 controls operation of the hotend 304 and feeding filament (not shown) through the hotend 304. In accordance with known techniques, the hotend 304 heats deposition material using the heat sink 308, wherein the head 306 deposits the material for 3D printing.

In one embodiment, the hotend 304 may be the E3Dv6 hotend available from E3D-Online Lmtd, United Kingdom.

In one embodiment, the printhead may be the printhead described in U.S. Pat. No. 10,189,205, the disclosure of which is hereby incorporated by reference.

In another embodiment, the 3D printer utilizes an improved hotend disposed within the printhead. Where prior hotends provide for heating of the deposition filament and subsequent deposition, these prior hotends can suffer from complications arising from heat artifacts. High heat is required to melt the filament and current techniques can be inefficient not only from having to generate the initial heat, but maintaining the heat levels and dissipation of the heat into the 3D printer itself.

The improved hotend increases operational efficiency with many techniques, including having a heater element wrapped around a central tube, such as a copper tube. The improved hotend includes embedding the wrapped heating element and tube within a cavity disposed in a heat sink. For example, the wrapped heating element and tube may be disposed within a heat sink, such as heat sink 308 of FIGS. 8-9. Therein, this embedding of the wrapped heating element forces the retention of heat towards the tube and the heat sink 308 allows for efficient management and dissipation of the heat during and after print operations.

For installation and operation, the deposition head 306 therein attaches to the heat sink 308, providing for higher efficiency in deposition operations, including better management of heat generation, heat retention and subsequent heat dissipation of the hotend.

In one embodiment of the improved hotend, electronics for controlling the hotend, as well as printhead fans, are included in an electronics module placed directly on the printhead. The electronics module placement minimizes the signal path for analog control, as well as the amount of wiring going to the printhead.

In one embodiment, the hotend 304 uses an induction heating element to heat the deposition material, instead of a resistive element. Replacing the wrapped heating element with an induction heating element allows maintenance of the heating induction element using electronic controls already disposed on the print module 302. The induction heating element allows for high efficiencies and quicker temperature changes. Within the print module 302, control electronics produce a high frequency driving signal.

Using a heating element or induction element improves over other hotend printhead techniques including improving operational efficiency and lowering power requirements. By reducing the heating mass, the printer is able to warm-up and change temperatures much quicker. By inclusion of wiring from a controller disposed on the printhead, this reduces connection wires, including less chance of exterior wires getting broken or coming loose. Moreover, the utilization of a simple inner core or chamber for heating the filament simplifies the filament path, reducing any likelihood of the hotend jamming and disrupting print operations.

Generated heat must be dissipated quickly and efficiently to ensure the proper print material deposition and long-term integrity of the head 306.

In FIG. 11, the z-axis displacement detection element is not visible. Whereas, FIG. 12 illustrates a different perspective view. The printhead 300 includes the hotend 304, heat sink 308 with the elements of the printhead 300. An optical sensor assembly 310 is disposed between the hotend 304 and the print module 302 for determining z-axis positioning.

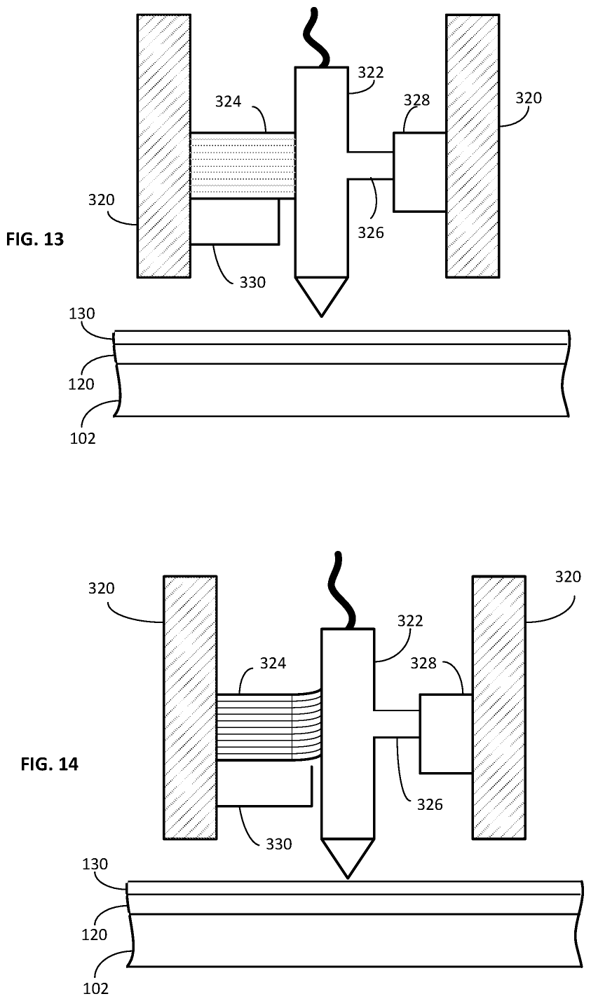

FIG. 13 illustrates a front view of an assembly including a printhead 320, including a hotend 322 attached with a connector 324. The hotend 322 includes an arm 326 that extends outward from the hotend 322. The assembly also includes an optical sensor assembly 328, where the arm 326 extends therein.

The printhead 320 is positioned over the vacuum bed 102, base member 120 and print surface member 130. 3D printing is performed by the deposition of material onto the print surface member 130 through the hotend 322 of the printhead 320.

While not readily visible, the optical sensor includes a light emitting source and a light detector. The emitting source is disposed on one side of the sensor assembly 328 and the detector on the other. During normal operations, the emitted light is occluded from the sensor by the arm 326. The arm 326 is positioned between the emitter and detector. Therefore, the optical detector does not register a change in light recognition. A preload stop 330 prevents downward movement of the connector 324.

In the above embodiment, the connector 324 may be a flexure assembly. The flexure has flexibility in the z-axis plane relative to the print surface member 130.

Prior to beginning printing operations, the printhead 320 must determine a home position, with specific requirements to the z-axis position, dictating the spacing between the hotend 322 and the print surface member 130.

While not readily visible, the optical sensor includes a light emitter and a light detector. The emitter is disposed on one side of the sensor assembly 328 and the detector on the other. Unless the hotend 322 is deflected as part of the calibration, the arm 326 partially blocks the emitted light from the detector. The arm 326 is positioned between the emitter and detector and the detector such that the detector receives a small amount of light.

In the above embodiment, the connector 324 may be a flexure assembly. The flexure is flexible in the z-axis plane relative to the print bed 330, and is stiff in the x and y axes. The connector 324 provides enough flexibility to ensure the hotend 322 can be displaced when the hotend 322 touches the print bed, but also have enough rigidity to ensure no unwanted movements during printing operations. For example, in one embodiment a stop member (not shown) connected to the printhead may preload a force against the connector 324 with enough force sufficient to prevent upward motion during normal printing operations, but small enough that the hotend 322 may be moved upward to trigger the sensing process without causing damage. The preload stop 330 engages the connector 324 at the point of contact between the connector 324 and the hotend 322. As the connector allows z-axis movement of the hotend 322, the stop 330 ensures the hotend 322 does not extend lower in the z-axis during the initialization phase, as well as during normal operations, but instead secures the proper z-axis position for the hotend 322.

Prior to beginning printing operations, the printhead 320 must determine a home position, with specific requirements to the z-axis position, dictating the spacing between the hotend 322 and the print surface member 130

FIG. 14 illustrates printhead 320 movement for z-axis calibration. The 3D printer moves the printhead 320 and hotend 322 close to the print surface member 130. When the hotend 322 engages the print surface member 130, the printhead 320 is able continue moving in the z-axis direction, but the hotend 322 cannot because its movement is being resisted by the print surface member 130. As the printhead 320 moves downward, the connector 324 absorbs the z-axis deflection without damaging the hotend 322.

The connector 324, in this embodiment being a flexure, flexes upward as the hotend 322 remains stationary relative to the print bed 100. As the optical sensor assembly 328 is affixed to the printhead 320, its position does not change relative to the printhead 320. Rather, as the movement of the hotend 322 is stopped by the print surface member 130 and the printhead 320 (and sensor assembly 328) continue to move downward, the position of the arm 326 is displaced within the sensor assembly 328. As the arm 326 is within the sensor assembly 328, the change in position of the arm 326 relative to the assembly 328 allows for the arm 326 to increase the amount of light that passes from the emitter to the detector. Also visible, the connector 324 is no longer in contacting engagement with the stop 330.

The hotend displacement distance relates to the z-axis measurement precision. In one embodiment, the displacement distance is approximately 5 microns for determining z-axis position within a precision of 5 microns. The present technique for detecting change in voltage provides that even a very small change in the position of the arm 326 obstructing the light path causes a measurable change in voltage. As described in further detail below, the analog measurement of voltage change makes this detectable.

It is recognized that the above exemplary embodiment of 5 micron movement is not limiting in nature. The detector is partially occluded from the emitter by the arm 326 because full occlusion introduces distance error that may be unaccounted for. For example, if the light is fully occluded and the arm moves 10 microns with the light still occluded, those 10 microns of movement cannot be detected. Therefore, partial occlusion allows for an alignment position and the z-axis deflection reduces the amount of occlusion causing a change in light passing to the detector and thus a change in detector voltage. Moreover, it is recognized that the partial occlusion and change in light passing to the detector may also be a downward change in light, such that movement of the arm increases the amount of occlusion again creating a voltage change.

As used herein, axial movement is relative. In the example of z-axis movement, the movement of the printhead is relative to the print bed. For example, one embodiment may include print bed movement where the printhead is stationary. In another embodiment, the printhead may be moved and the print bed is stationary. It another embodiment, both the printhead and the print bed may be moved. Therefore, the herein described z-axis movement of the print bed is relative to the printhead and vice versa such that measurable z-axis displacement occurs and the z-axis movement is not expressly limited to solely moving the printhead.

Moreover, the z-axis position determination, further allows for self-leveling of the 3D printer system. For example, in a 3D printer system assembled using the modular connective outer structure described herein and the vacuum print bed can use the z-axis position detection to self-level prior to printing operations. For example, the 3D printer system can select three or more different X,Y axes print bed positions and determine Z axis depths for each position. From these Z axis positions, the 3D printer can thus self-level the printhead by defining the Z axis plane across the print bed.

The hotend 304 and nozzle 306 with the heat sink 308 disposed around thereby improves 3D printing operations. Further improvements are found by the placement of circuitry within the hotend 304 itself.

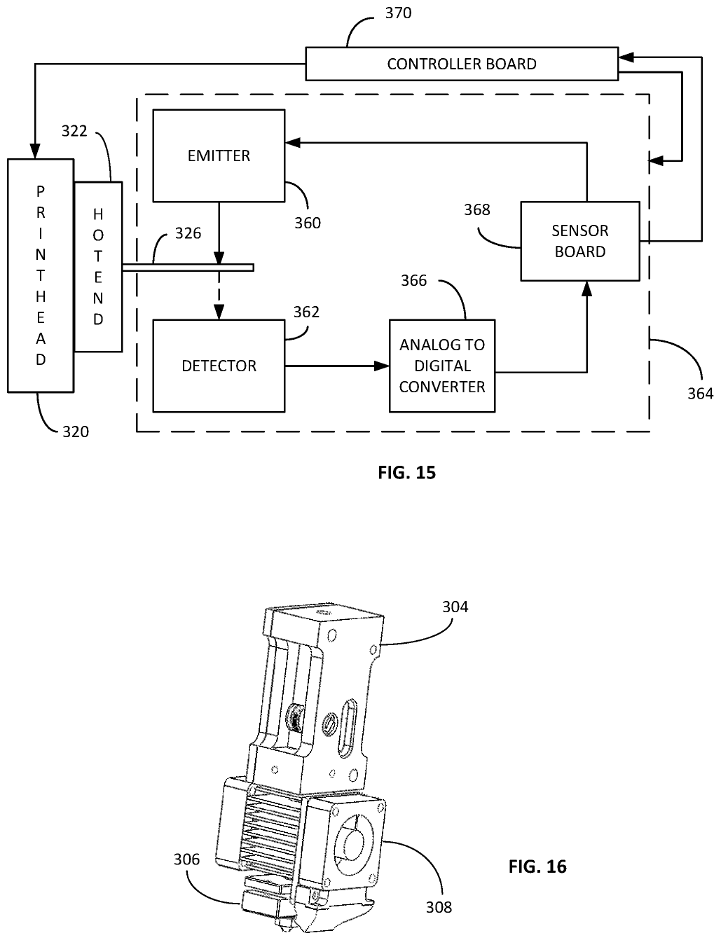

FIG. 15 illustrates an operational diagram of the z-axis calibration, including an emitter 360 and a detector 362, which are part of an optical sensor assembly 364. The assembly 364 further includes an analog to digital converter 366 and a sensor board 368.

A controller board 370 controls positional operations for the printhead 320, thus also moving the hotend 322. Also shown for illustration of operational features, the arm 326 extends out from the hotend 322 between the light source 360 and sensor 362.

Illustrated in FIG. 15, two arrows extend between the emitter 360 and detector 362, indicating two operational stages: a first stage when the light is partially occluded by the arm 326; and a second stage when the arm 326 is displaced and increased light reaches the detector 362.

The emitter 360 may be any suitable type of light source capable of providing a directed beam of light. In one embodiment, the emitter is a light emitting diode consistent with known optical sensor technology, but it is recognized that any suitable light source may be utilized. Similarly, the detector 362 may be any suitable type of light sensor as recognized by one skilled in the art, where the light sensor generates an analog voltage output based on the amount of light detected.

It is recognized that any suitable electronic components may be utilized for performance of the operations described herein. By way of example, but not expressly limiting, the light may be an LED, disposed in a photointerrupter RPI-0352E available from Rohm Semiconductor.

As part of the improved 3D printer assembly, various print components are interchangeable. It is recognized that in deposition printing, it is not uncommon for the printhead to become clogged, or for controller mechanisms to need replacement. Modular integration of print components allows for reducing 3D printer downtime to swap out replacement components.

Modular construction and management of 3D printer components enhances the sequencing of multiple print job by overcoming malfunction errors. Where current 3D printers, when encountering an operational error, can require replacement of the full print assembly, modular construction allows for quick replacement of malfunctioning components. For instance, as illustrated in FIG. 11, a printhead 300 includes multiple components, modular construction separates out these components, as well as integration of the components into the 3D printer itself.

In the modular embodiment, FIG. 16 illustrates another view of the hotend 304, disengaged from the print module 302 of FIG. 8. The hotend 304 provides for deposition printing, including the heat sink 308 is disposed around the nozzle 306. The hotend 304 includes connector pads or elements (not expressly illustrated) that engage a print module and receive communication commands from the print module. During operations, the hotend 304 is connected to a controller, such as print module 302 of FIG. 8.

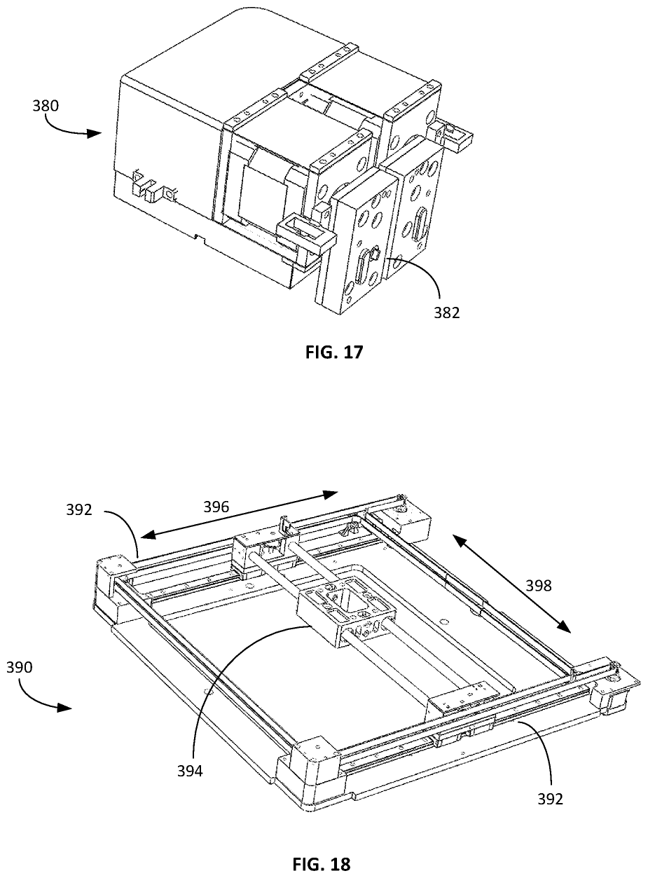

FIG. 17 illustrates a print module 380 that includes connector pads 382 for contacting engagement with the printhead 304 of FIG. 16. The print module 380 is similar to the print module 302 of FIG. 11, but the print module 380 allows for connection of two hotends (e.g. 304 of FIG. 16). For example, multiple hotends may be used to deposit contrasting deposition materials.

The print module 380 includes functional components for controlling deposition of material by controlling the operation of the hotend 304 of FIG. 16 when connected. The hotend 304 of FIG. 16 connects to the print module 380 by being secured against the connector pads 382, such as via a magnetic fit, a pressure fit, or any other suitable means. During operations, the print module 380 controls the deposition of print material by the hotend 304 of FIG. 16. Moreover, it is recognized that any suitable type of printhead may be utilized, whereas the print module 380 is not expressly limited to the deposition-type printing illustrated herein.

FIG. 18 illustrates a perspective view of the x-y axis printing control assembly 390. In this embodiment, control rails 392 move the block 394 in a first axis 396. Within the assembly 390, control mechanisms additionally move the block 394 in the second axis 398. For example, one embodiment may include cable or other means with rotary controls to control the first and second axis movement.

In the modular embodiment, the print module 380 of FIG. 17 can then be inserted into the block 394. The print module 380 (FIG. 17) is then moveable in multiple axes, with deposition via the hotend 304 (FIG. 16). Modularity allows for interchanging of components or elements without significant disruption of a print job, as well as overall print queue(s).

A further benefit of the present 3D printing system, including modularity of printing components, is the ability to automate not only individual printing operations, but also multiple printing operations. For example, the vacuum bed allows for automated print job removal without disruption of other print jobs, such as by simply turning off the vacuum force for a segment of the print base allows for quick and easy print job removal. The assembly elements allow for adjusting the size of the 3D printing system, allowing for large scale print jobs or multiple print jobs sharing the same print base. The printhead as described herein, including in FIGS. 11-12 allow for modular replacement of any malfunctioning components without requiring restarting any printing operations. The printhead self leveling and z-axis techniques allow for automated print job starting with secure knowledge of z-axis positions.

Therefore, the present 3D printing system can further function using an automated arm to manage print operations, such as placement of a print surface member on the base member on the vacuum print bed, removing of print jobs once printing is completed and loading another print surface member for a next job. In another embodiment, if a printhead component malfunctions during print operations, the same automation may replace printhead elements as necessary.

In operations with computational controllers, described herein, a robotic control mechanism can then automate multiple print jobs over an extended period of time without requiring human oversight and intervention. The vacuum print bed eliminates the long delay required to cool the print base for print job removal and reheating prior to beginning another print job. For example, the print bed may be segmented, so that vacuum air flow can be shut-off for a portion of the print bed, allowing for multiple print jobs to be executed, removing a single print job without disruption of the other print jobs. The improved printhead, including the improved hotend improves operational efficiencies allowing for extending 3D printing operations.

For print jobs operations, the software may include processing operations using known g-code file generation techniques. One embodiment may include insertion of meta-tags of other identifiers for the g-code file usable for sorting or queuing the print operations.

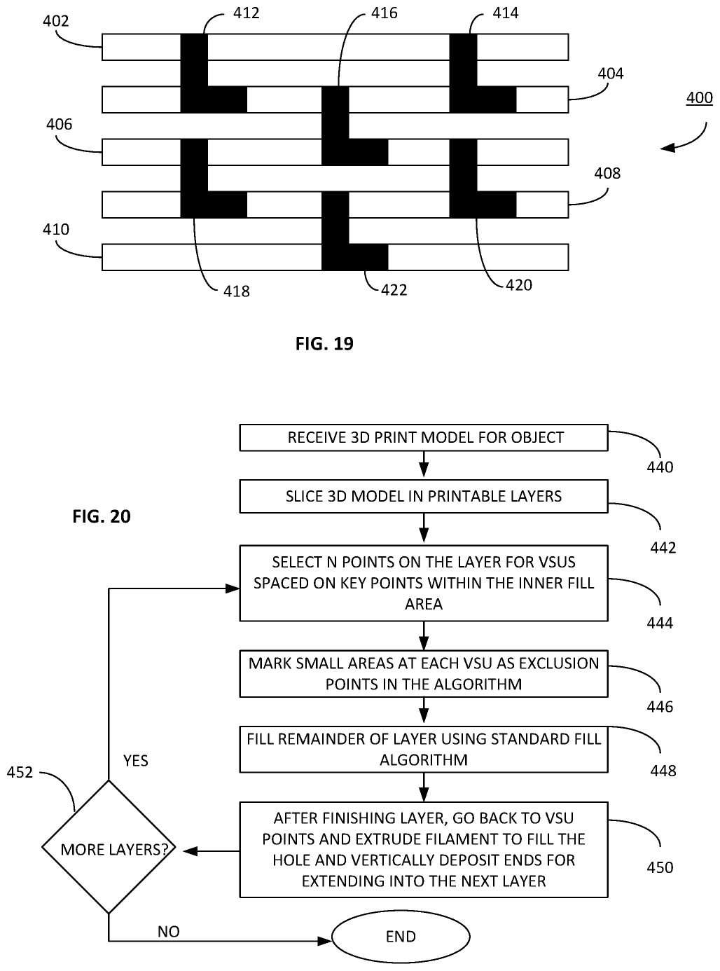

For complications relating to Z axis stability of a printed 3D object, FIG. 19 illustrates a vertical strengthening technique. FIG. 19 illustrates a cross-section of a 3D printed object 400, magnified showing the specific deposition layers 402, 404, 406, 408 and 410 (collectively referred to as layers 402-410). These layers are formed during print operations, representing a layer of material deposited by the 3D printhead.

In this deposition technique, FIG. 19 further illustrates the inclusion of vertical strength units (VSUs) 412, 414, 416, 418, 420 and 422 (collectively referred to as VSUs 412-422). The VSUs 412-422 are disposed between adjacent deposition layers 402-410, providing vertical stability. The VSUs are 412-422 are placed in holes left in the inner fill for the layer and when the next layer is printed, these VSUs 412-422 effectively fuse the adjacent layers 402-410 together.

The VSUs 412-422 may be made of any suitable material allowing for rigidity between the layers 402-410. By way of example, but not expressly limiting in nature, the VSUs 412-422 may be made of plastic filament deposited into predetermined locations.

In one embodiment, the VSU is just a bit of the same plastic as in the rest of the 3D print object. Wherein, for the VSU, extrusion of deposition material occurs as the printhead moves vertically (in the Z axis) instead of horizontally (in the X and/or Y axis). The main strength of the filament occurs in the extrusion direction. Thus, the VSUs provide concentrated points where the filament travels vertically, providing a significant strengthening point for the overall structure.

FIG. 20 illustrates a flowchart of the steps of one embodiment of a method for modification of a print object for inclusion of VSUs. Step 440 is to receive a 3D model of the print object, consistent with known 3D printing techniques. Step 442 is to slice the 3D model into layers, consistent with known printing techniques.

Step 444 is to selecting N number of points on a print layer for inclusion of VSUs, where N is any suitable integer value. The VSUs are disposed at key points of layer within the inner fill area. Determining these key points may be electronically determined using a computerized algorithm or can be determined manually by a user, such as a user managing the print job. The VSUs are denoted in the g-code file as exclusion points, cavities or empty areas to be avoiding during the layer deposition.

Step 446 is marking small areas at each VSU as exclusion points in the printing algorithm. Step 448 of the technique is filling the remaining of the layer using a standard fill algorithm.

In step 450, after finishing the rest of the layer, go back to the VSU print and extrude filament to fill the hole and then vertical slightly to produce nubs extending into the next layer.

For 3D object printing, the object has numerous layers, thus step 452 is determining if more layers are to be printed. If yes, the technique reverts back to step 444 and repeats, printing the additional layer with vertical supports. If no, the present technique is therefore concluded.

Therein, the present technique improves vertical stability for print objects by modification to the printing routine. In one embodiment, the vertical stability modification is a software solution to existing printing software technology, by inclusion of VSU exclusion points in the print modeling. During modeling, these exclusion points are added for printing operations, whereby the printhead additionally includes filament members for stability.

Accordingly, improved techniques providing for improved 3D printing as described herein. The air flow enabled print bed ensures secure placement of the object prior to print completion. The modular assembly technique provides for improved easy of manufacture and assembly, as well as adjustments of print sizing. The improved printhead includes a heat sink disposed internally therein for improved heat and cooling properties. The printhead itself includes z-axis position detection techniques. The inclusion of VSU insertion techniques in software modeling and printing further improves the print operations by including vertical stability for the print object. Moreover, inclusion of an automated print control operation and software for print job queuing, prioritization, allows for multiple print jobs to be executed in consecutive fashion, without human oversight.

FIGS. 1 through 20 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A 3D printer comprising:
a vacuum bed having a plurality of air vents disposed therein for transmitting a vacuum force therethrough, wherein the air vents of the vacuum bed include a plurality of equally spaced holes in a grid pattern;
a base member having a first dimension for being affixable on top of the vacuum bed, wherein the base member is composed of a permeable material; and
a print surface member having a non-permeable surface with a second dimension for being affixable on top of the base member, the second dimension of the print surface member fitting within the first dimension of the base member;
wherein the vacuum force transferred by the vacuum bed is dispersed through the permeable material of the base member and applied against the print surface member securing the print surface member in place within the first dimension of the base member for deposition of a print material by the 3D printer on the print surface member.

2. The 3D printer of claim 1, wherein the base member has a thickness between 0.05 inches and 0.005 inches.

3. The 3D printer of claim 1, wherein the base member is composed of foam aluminum.

4. The 3D printer of claim 1, wherein the base member is composed of at least one: foam, cardboard, wood fiber board, and paper.

5. The 3D printer of claim 1, the print surface member having an adhesive on a bottom side of the print surface member, the adhesive securing the print surface member to the base member during 3D printing.

6. The 3D printer of claim 5, wherein the adhesive provides for securing the print surface member to the base member prior to the removal of the print surface member from the base member upon completion of the 3D printing.

7. A 3D printer comprising:
a vacuum bed having a plurality of air vents disposed therein for transmitting a vacuum force therethrough, wherein the air vents of the vacuum bed include a plurality of equally spaced holes in a grid pattern;
a heating element associated with the vacuum bed for heating up the vacuum bed;
a base member having a first dimension for being affixable on top of the vacuum bed, wherein the base member is composed of a permeable material; and
a print surface member having a non-permeable surface with a second dimension for being affixable on top of the base member, the second dimension of the print surface member fitting within the first dimension of the base member;
wherein the base member transfers heat from the vacuum bed to the print surface member;
wherein the vacuum force transferred by the vacuum bed is dispersed through the permeable material of the base member and applied against the print surface member securing the print surface member in place within the first dimension of the base member for deposition of a print material by the 3D printer on the print surface member, the deposition of the print material aided by the heat transferred to the print surface member from the heating element.

8. The 3D printer of claim 7, wherein the base member has a thickness between 0.05 inches and 0.005 inches.

9. The 3D printer of claim 7, wherein the base member is composed of foam aluminum.

10. The 3D printer of claim 7, wherein the base member is composed of at least one: foam, cardboard, wood fiber board, and paper.

11. The 3D printer of claim 7, the print surface member having an adhesive on a bottom side of the print surface member, the adhesive securing the print surface member to the base member during 3D printing.

12. The 3D printer of claim 11, wherein the adhesive provides for securing the print surface member to the base member prior to the removal of the print surface member from the base member upon completion of the 3D printing.

13. A 3D printer comprising:
a vacuum bed having a plurality of air vents disposed therein for transmitting a vacuum force therethrough, wherein the air vents of the vacuum bed include a plurality of equally spaced holes in a grid pattern;
a base member having a first dimension for being affixable on top of the vacuum bed, wherein the base member is composed of a permeable material; and
a print surface member having a non-permeable surface with a second dimension for being affixable on top of the base member;
a z-axis detection system disposed within the 3D printer printhead, such that the printhead is operative to self level itself using the z-axis detection system; and
wherein the vacuum force transferred by the vacuum bed is dispersed through the permeable material of the base member and applied against the print surface securing the print surface in place for deposition of a print material by the 3D printer on the print surface member.

14. The 3D printer of claim 13, wherein the z-axis detection system includes:
a controller determining a zero position of the 3D printer printhead in an x-axis and a y-axis, as well as finding an initial position for position of the printhead in the z-axis;
a hotend of the 3D printer printhead for deposition of the deposition material, the hotend connected to the 3D printer printhead via a connector moveable in the z-axis, the hotend including an arm extending outward therefrom;
an optical sensor assembly including an emitter and a detector, the optical sensor assembly directly affixed to the 3D printer printhead, where at the initial position in the z-axis, the arm of the hotend extends in-between the emitter and the detector; and
wherein the controller calibrates a starting position for the 3D printer printhead based on z-axis movement of the printhead distinct from the hotend as facilitated by the connector, causing z-axis displacement of the arm on the hotend, the z-axis displacement allowing the detector to detect a change in light from the emitter.

15. The 3D printer of claim 14, wherein the connector is at least one of: a flexure assembly and a linear rail including a spring element.

16. The 3D printer of claim 14, wherein the starting position between the 3D printer printhead and a print bed is known within a distance of less than 10 microns.

17. The 3D printer of claim 13, wherein the z-axis detection system includes:
a controller controlling movement of 3D printer printhead moveable in a first axis;
a hotend of the 3D printer printhead for depositing the deposition material, the hotend connected to the 3D printer printhead via a connector moveable in the first axis, the hotend including an arm extending outward therefrom;
an optical sensor assembly including an emitter and a detector, the optical sensor assembly affixed to the 3D printer printhead; and
wherein the controller calibrates a starting position for the 3D printer printhead based on first axis movement of the printhead relative to a print bed, the first axis movement distinct from the hotend as facilitated by the connector and detected by the arm interacting with the optical sensor assembly.

18. The 3D printer of claim 17, wherein the printhead is a deposition printhead.

19. The 3D printer of claim 17, wherein movement in the first axis is movement in the z-axis plane of movement.

20. The 3D printer of claim 17, wherein the connector is a flexure assembly.
